(19) United States
(12) Patent Application Publication
(10) Pub. No.: US 2010/0184497 A1
(43) Pub. Date: Jul. 22, 2010

(54) INTERACTIVE MUSICAL INSTRUMENT GAME

(76) Inventor: BRUCE CICHOWLAS, FRAMINGHAM, MA (US)

Correspondence Address: AKC PATENTS, 215 GROVE ST., NEWTON, MA, 02466, US

(21) Appl. No.: 12/690,521

(22) Filed: Jan. 20, 2010

Related U.S. Application Data
(60) Provisional application No. 61/146,064, filed on Jan. 21, 2009.

(51) Int. Cl. A63F 9/24; A63F 13/00

(52) U.S. Cl. 463/7; 463/37; 463/40; 463/31

(57) ABSTRACT

An interactive musical instrument game includes playing the notes of a song segment or a song on a real musical instrument as prompted by a game display and in coordination with a recorded recognized song or song segment. The display is configured to display a virtual musical instrument corresponding to the real musical instrument. The virtual musical instrument includes virtual keys corresponding to the real keys of the real musical instrument. A music application causes a specific musical recording of a song or a song segment to be played and highlights simultaneously the associated specific virtual keys and the corresponding real keys during the playing of the specific musical recording with the same designation.

### CROSS REFERENCE TO RELATED CO-PENDING APPLICATIONS

This application claims the benefit of U.S. provisional application Ser. No. 61/146,064 filed on Jan. 21, 2009 and entitled INTERACTIVE MUSICAL INSTRUMENT GAME which is commonly assigned and the contents of which are expressly incorporated herein by reference.

### FIELD OF THE INVENTION

The present invention relates to an interactive musical instrument game and in particular to an electronic game that utilizes a real musical instrument for providing game input as prompted by a game display and usually in coordination with a recorded recognized song or song segment.

### BACKGROUND OF THE INVENTION

The idea of teaching the playing of an actual keyboard instrument through a computer has been discussed in prior art documents, such as US2006/0252503. There are also several prior art systems in the market that try to teach piano through a computer, notably the Miracle Piano Systems, published by Software Toolworks, Nintendo, Synthesia published by HDPiano.com, among others. However, these devices are primarily intended for education, and in general are not effective in having fun with music or learning to play actual phrases and parts of music.

There are also several electronic games that receive game input from musical instruments, such as Guitar Hero, published by RedOctane. However, these systems utilize mock-type (i.e., not “real”) musical instruments and do not provide significant music education value. A “real” musical instrument, as defined here, has means for selecting the “pitches” of a song and includes both actual instruments and musical instrument simulators that have places on the instrument that can be associated with a “pitch”. “Pitch” represents the perceived fundamental frequency of a sound.

Accordingly, there is a need for a musical instrument teaching method and system that is fun to play as a game and more effective than presently available music teaching systems and methods.

### SUMMARY OF THE INVENTION

The invention provides an electronic game that utilizes a real musical instrument for providing game input as prompted by a game display and usually in coordination with a recorded recognized song or song segment.

In general, in one aspect, the invention features an interactive musical game system including a real musical instrument, a computing unit and a display. The real musical instrument includes real keys configured to be manipulated by a player for playing music and thereby providing game input. The computing unit communicates with the real musical instrument and includes a database and a music application. The display is connected to the computing unit and is configured to display a virtual musical instrument corresponding to the real musical instrument. The virtual musical instrument includes virtual keys corresponding to the real keys of the real musical instrument. The database includes musical recordings and data specific to each musical recording that associate pitches of each musical recording with a specific manipulation sequence of the virtual keys. The music application causes a specific musical recording to be played and highlights simultaneously the associated specific virtual keys and the corresponding real keys during the playing of the specific musical recording with the same designation. The display further displays a score board, a target bar located above the virtual musical instrument and one or more lines diverging from a common starting point and end at a point of the target bar located directly over a highlighted virtual key, thereby indicating the specific manipulation sequence of the virtual keys during the playing of the specific musical recording. Manipulation of the highlighted real keys by the player coinciding with the simultaneously displayed manipulation sequence of the highlighted virtual keys during the playing of the specific musical recording causes a positive scoring event in the score board in real-time.

Implementations of this aspect of the invention may include one or more of the following features. Manipulation of the highlighted real keys by the player not coinciding with the simultaneously displayed manipulation sequence of the highlighted virtual keys during the playing of the specific musical recording causes a negative scoring event in the score board. No manipulation of the highlighted real keys by the player coinciding with the simultaneously displayed manipulation sequence of the highlighted virtual keys during the playing of the specific musical recording causes a negative scoring event in the score board. The musical recordings may be songs, song segments, musical arrangements, instrumental musical pieces or vocal musical pieces. The computing unit communicates with the real musical instrument via musical instrument digital interface (MIDI) communications. The game system may further include a first set of speakers broadcasting sound generated from the playing of the musical recordings and/or the playing of the real musical instrument. The game system may further include a second set of speakers broadcasting sound generated from the playing of the real musical instrument. The real musical instrument may be an electronic keyboard, a synthesizer, a Keytar, a computer keyboard in which the keys are software mapped to correspond to music notes, a saxophone, a guitar, a EWI, a non-full size electronic keyboard, a touch pad, or a gesture-triggered controller. The display may further display one or more time prompts running along the one or more lines, respectively. The time prompts hit the target bar at the point located directly over the highlighted virtual key at the time the player needs to hit the corresponding real key. The real musical instrument may further include means for highlighting simultaneously the real keys with the virtual keys with the same designation. The designation may be light, colors, shapes, numbers, letters, textures, font type, font size, or key relative position. The real musical instrument may further include a lighting source for highlighting simultaneously the real keys with the same colors as the corresponding virtual keys. The lighting source may be a projector receiving an image of the lighted virtual keys of the virtual musical instrument and projecting the image onto the real keys of the real musical instrument. The game system may further include one or more additional real musical instruments configured to be manipulated by the player or by one or more additional players and wherein the display is further configured to display one or more additional virtual music instruments corresponding to the one or more additional real musical instruments. The computing unit may be a computer, a Playstation, an Xbox, a Wii, a PlayStation, a Nintendo DS, a game controlling device or a handheld game controlling device. The display may be a computer display, a television display, a projected display, a video game console, or an arcade machine display.

In general, in another aspect, the invention features a method for an interactive musical game including providing a real musical instrument, providing a computing unit and providing a display. The real musical instrument includes real keys configured to be manipulated by a player for playing music and thereby providing game input. The computing unit communicates with the real musical instrument and includes a database and a music application. The database includes musical recordings and data specific to each musical recording that associate pitches of each musical recording with a specific manipulation sequence of the virtual keys. The display is connected to the computing unit and is configured to display a virtual musical instrument corresponding to the real musical instrument. The virtual musical instrument comprises virtual keys corresponding to the real keys of the real musical instrument. The music application causes a specific musical recording to be played and highlights simultaneously the associated specific virtual keys and the corresponding real keys during the playing of the specific musical recording. The display further displays a score board, a target bar located above the virtual musical instrument and one or more lines diverging from a common starting point and end at a point of the target bar located directly over a highlighted virtual key, thereby indicating the specific manipulation sequence of the virtual keys during the playing of the specific musical recording. Manipulation of the highlighted real keys by the player coinciding with the simultaneously displayed manipulation sequence of the highlighted virtual keys during the playing of the specific musical recording causes a positive scoring event in the score board. Manipulation of the highlighted real keys by the player not coinciding with the simultaneously displayed manipulation sequence of the highlighted virtual keys during the playing of the specific musical recording causes a negative scoring event in the score board. No manipulation of the highlighted real keys by the player coinciding with the simultaneously displayed manipulation sequence of the highlighted virtual keys during the playing of the specific musical recording causes a negative scoring event in the score board.

### BRIEF DESCRIPTION OF THE DRAWINGS

FIG. 1 depicts a schematic diagram of the hardware architecture for the interactive musical instrument game of this invention;

FIG. 2 is an another embodiment of the hardware architecture for the interactive musical instrument game of this invention; and

FIG. 3 depicts a block diagram of the process of developing the interactive musical instrument game of this invention;

FIG. 4 depicts a block diagram of the process of playing the interactive musical instrument game of this invention;

FIG. 5A-5B depict typical examples of song segments;

FIG. 6A depicts the “Mary Had A Little Lamb” song segment;

FIG. 6B-6C depict the corresponding multi-colour lighting of the focused keyboard for the song segment of FIG. 6A played in the C-key and Eb key, respectively;

FIG. 7 depicts a song (Doors “Light My Fire) with three different song segments;

FIG. 8-10 depict the lighting of focused keyboard for the song segments of FIG. 7;

FIG. 11A depicts a song segment of “Two Hearts That Beat As One” by U2;

FIG. 11B depicts the lighting of the focused keyboard for the song segment of FIG. 11A;

FIG. 12A depicts a song segment (Roy Orbison's Blue Bayou);

FIG. 12B depicts the lighting of the focused keyboard for the song segment of FIG. 12A;

FIG. 13A-13C depict a simplified right-hand accompaniment pattern to John Lennon's “Imagine” and its representation on the focused keyboard of this invention;

FIG. 13E depicts left (572) and right (574) groups of notes accompaniment pattern to John Lennon's “Imagine” and their corresponding representations on a non-focused keyboard;

FIG. 13F depicts a scale-oriented system for a song in the key of C major and the corresponding non-focused keyboard with multi-color key lighting;

FIG. 14 depicts the display of FIG. 1;

FIG. 15 depicts a game scoring indication in the display of FIG. 14;

FIG. 16 depicts an alternative game scoring indication in the display of FIG. 14;

FIG. 17A depicts an alternative keyboard for game 100 of FIG. 1;

FIG. 17B depicts an arcade version of game 100 of FIG. 1.

FIG. 18 depicts a method of showing the players the audio balance between what they are playing and what the recorded band is playing;

FIG. 19A depicts a guitar with multi-color lighted fretboard for the song segment of FIG. 6A played in the C-key;

FIG. 19B depicts a bass guitar with multi-color lighted fretboard for the song segment of FIG. 6A played in the C-key;

FIG. 19C depicts a soprano sax with multi-color lighted keys for the song segment of FIG. 6A played in the C-key;

FIG. 19D depicts an alto sax with multi-color lighted keys for the song segment of FIG. 6A played in the C-key; and

FIG. 19E depicts an Electronic Wind Instrument (EWI) with multi-color lighted key for the song segment of FIG. 6A played in the C-key.

### DETAILED DESCRIPTION OF THE INVENTION

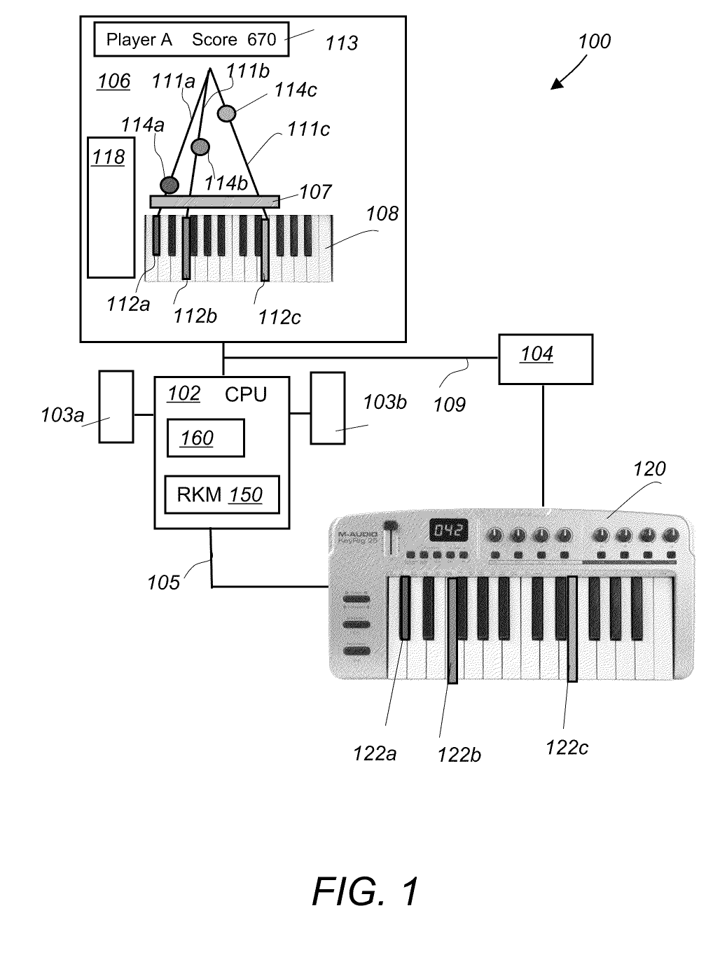

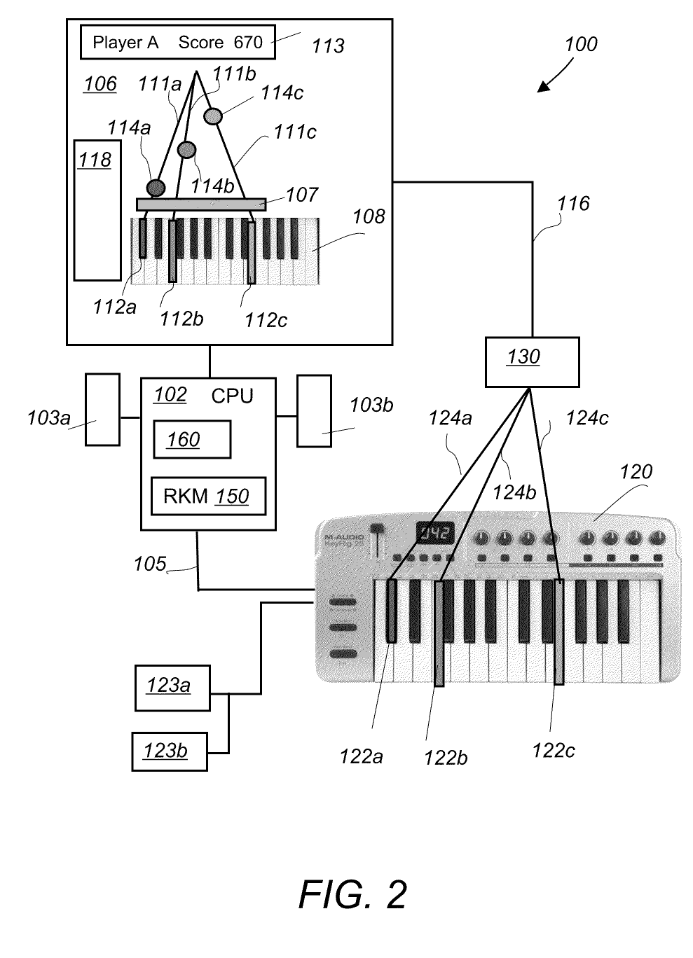

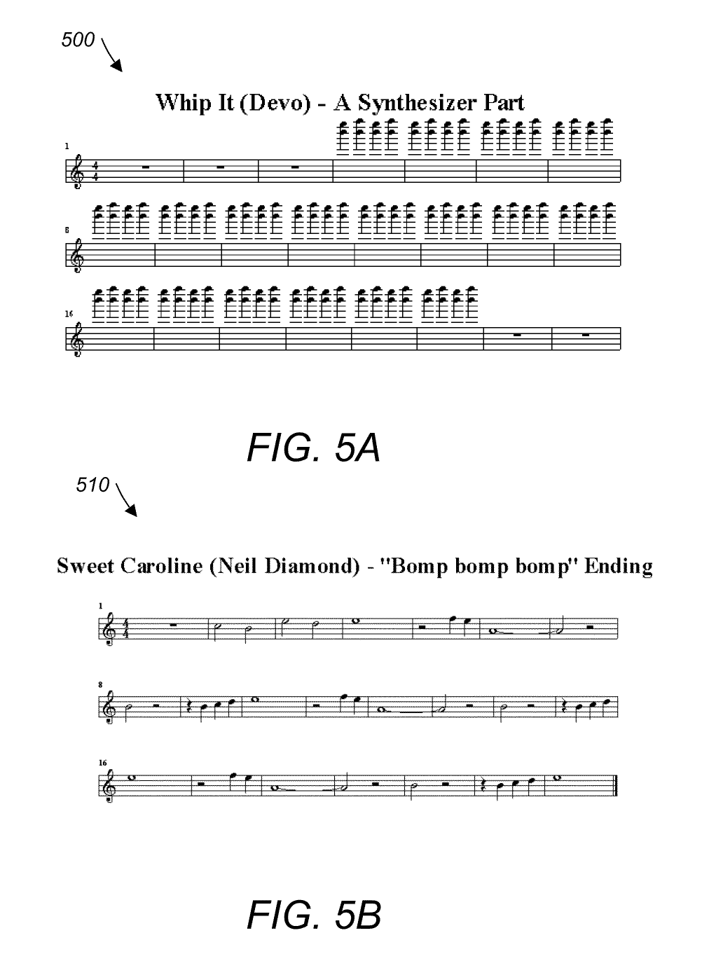

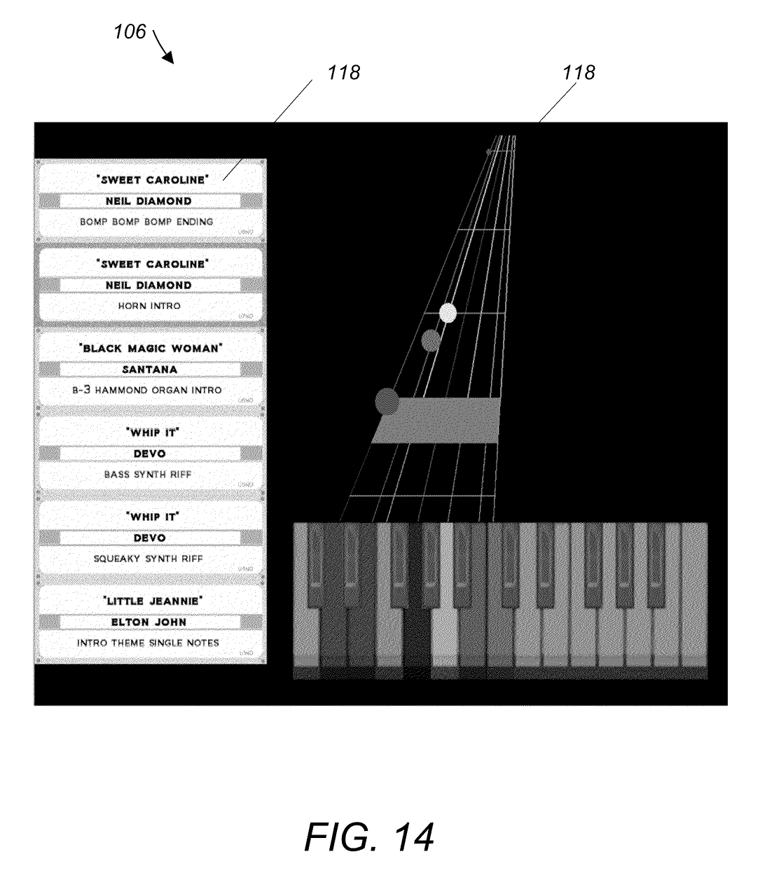

Referring to FIG. 1, an interactive musical instrument game 100 includes an actual musical instrument 120 and a computing unit 102 connected to the musical instrument 120 and to a display 106 and to speakers 103a, 103b. The computing unit 102 may be a computer, an Xbox, a Wii, a Playstation or any other computing or game controlling device. The computing unit 102 includes the Real Key Music (RKM) software 150 and a library 160. Library 160 is a digital storage unit including recorded songs, song fragments, musical arrangements, instrumental musical pieces, and vocal musical pieces, among others. Examples of song segments are shown in FIG. 5. In other embodiments, library 160 may be a database stored in an external storage device or may be downloaded from an online web-site via a network connection. Speakers 103a, 103b may be separate speakers or may be integrated within the computer 102, the musical instrument 120, or the display 106. Speakers 103a, 103b broadcast sound generated from the playing of the recorded musical pieces and/or the playing of the actual musical instrument 120. In the embodiment of FIG. 2, musical instrument 120 includes a second set of speakers 123a, 123b dedicated for broadcasting music played on the musical instrument itself. In FIG. 1, the musical instrument 120 is shown to be an actual electronic keyboard. In this example, musical instrument 120 is a 25-key electronic keyboard manufactured by M-Audio. It includes 15 white keys and 10 black keys. In other embodiments, musical instrument 120 may be any type of electronic keyboard or synthesizer having different number of keys and controls, a Keytar (i.e., a keyboard or synthesizer supported by a strap around the neck and shoulders of the player) a computer keyboard in which the keys are software mapped to correspond to music notes, a saxophone, a guitar, or any other musical instrument. Library 160 includes, in addition to the recorded songs, data specific to each song which associate the pitches of the song with specific keys in the keyboard, as will be described below. “Pitch” represents the perceived fundamental frequency of a sound and in this case the song pitches represent the set of perceived fundamental frequencies that characterize the song or song segment. The display 106 may be a computer display, a TV, a video game console, an arcade machine display or any other display device. Display 106 displays the image of a virtual keyboard 108 corresponding to the actual keyboard 120, colored lines 111a-111c, prompts 114a-114c and a target bar 107. The virtual keyboard 108 is designed to have the same number of keys as the actual keyboard 120. The displayed image is controlled by the RKM software 150. The RKM software 150 causes specific keys 112a-112c of the virtual keyboard 108 to become highlighted with different colors depending on the pitches of the song that is played. Lines 111a-111c diverge from a common starting point and end at a point directly over the keys that are highlighted. They are spaced apart by non-equal spaces and the common starting point may be off the screen. As different keys are highlighted during the playing of a song, the end points of lines 111a-111c move to point toward the keys that are highlighted while their starting point remains fixed. In this way they act as visual pointers toward the keys that are hit on the virtual keyboard 108 and therefore need to be hit on the actual keyboard 120. Prompts 114a-114c run along lines 111a-111c, respectively, and extinguish after they arrive at the target bar 107. The time prompts 114a-114c hit the target 107 corresponds to the time the player needs to hit the corresponding keys on the actual keyboard 120 in order to have a successful score. Keys 112a-112c, lines 111a-111c and prompts 114a-114c have the same color respectively. In one example key 112a, line 111a and prompt 114a are red, key 112b, line 111b, and prompt 114b are green and key 112c, line 111c, and prompt 114c are blue. Display 106 also includes a list of the available songs and song segments 118, as shown in FIG. 14.

The system also includes a bidirectional communication mechanism 104 between the computer 102 and the instrument 120. Mechanism 104 causes specific keys 122a-122c on the actual keyboard 120 to get highlighted based on signals controlled by the RKM software 150 and received from the computer 102 during the playing of a song. Mechanism 104 also transmits signals from the keyboard keys to the computer 102. The highlighted specific keys 122a-122c on the keyboard 120 correspond to the pitches of the song that is played. In one example, mechanism 104 is implement via bidirectional musical instrument digital interface (MIDI) communications. MIDI is an industry standard protocol that enables electronic musical instruments and computers to communicate, control, synchronize and exchange data with each other. A MIDI instrument or controller transmits “event messages” such as the pitch and intensity of the musical notes that are played, control signals for parameters such a volume and vibrato and clock signals to set the tempo. When a musical performance is played on a MIDI instrument (or controller) it transmits MIDI channel messages from its MIDI Out connector.

A typical MIDI channel message sequence corresponding to a key being struck and released on a keyboard includes the following:

The user presses the middle C key with a specific velocity (which is usually translated into the volume of the note) and the instrument sends one Note-On message.

The user changes the pressure applied on the key while holding it down—a technique called Aftertouch and the instrument sends one or more Aftertouch messages.

The user releases the middle C key, again with the possibility of velocity of release controlling some parameters and the instrument sends one Note-Off message.

Note-On, Aftertouch, and Note-Off are all channel messages. For the Note-On and Note-Off messages, the MIDI specification defines a number (from 0-127) for every possible note pitch (C, C #, D etc.), and this number is included in the message.

In one example, a MIDI channel message includes the following four parts:

(1) the “command”—in this case NoteOn (0x80) or NoteOff(0x90)
(2) the “channel”—any channel could be consistently used, for example channel 1.
(3) data1—this is the MIDI pitch
(4) data2—for NoteOn, this is the “velocity”, which in the present invention is used to indicate the type of highlighting. NoteOff is then used to turn off the highlighting for that note.

Sometimes a NoteDown message with a velocity of zero actually indicates a Note release, making it not necessary to implement the NoteUp messages. In other implementations the velocity may be used for the note highlighting messages. If the velocity were non-zero, the velocity could be interpreted as an indication of how a note should be highlighted, selecting one of up to 127 possible colors, for example. Alternately, the seven bits of the velocity could be interpreted as a color, using for instance two bits for red intensity, three bits for green intensity and two bits for blue intensity. This would result in three possible red illumination levels (besides off), seven possible green intensity levels besides off, and three possible blue levels besides off, which can then be combined in a red-green-blue (RGB) fashion into one of 127 possible colors. Since the colors need to be easily distinguishable from one another in the described application, it is hard to imagine a situation in which more than 127 color shades might be needed. But if that should become necessary, additional bits could be conveyed. For instance, if two notes on messages for the key were sent in rapid succession, the velocity data of the second message could be interpreted as additional bits, giving a total of 14 bits instead of 7, and 17,367 shades besides completely off.

In implementations where independent signals are used for the three RGB components, one MIDI channel is used for red intensity, one for green intensity and one for blue. Similarly, the highlighting may utilize a subtractive color technology rather than an additive one, and the intensities of concern will be cyan, yellow and magenta instead of red, green and blue.

In alternate implementations, the “highlighting” method may not use color at all and it may have very few or even just one level (or color) other than off. For instance, keys may be physically moved slightly to show that they were highlighted or made to vibrate or physically “hum” or be of a different temperature or conduct heat differently, which one could easily discern through touch.

Another way to convey the control information through MIDI is to convey it as “controller” information rather than as “note channel” information. “SysX” technology may be used in this implementation. The exact use of channels and message content is defined almost arbitrarily and combined in various ways with other messages, but the meaning attached to the messages includes the highlighting message info above.

In any of these systems, there may be “panic” messages which causes all highlighting to reset to off. In addition to or in place of the messages above instructing single keys to highlight, “bulk” messages may be used which would give the keyboard a new highlighting scheme to use in place of the current one. These messages may be implemented in MIDI, XML, JSON or some other technology.

In one particular implementation, the music keys are considered to be numbered from 0 successively left to right, regardless of their MIDI pitch. In this implementation the instruction: “2,0; 3,1; 4,2; 7,3; 10,4; 11,5” tells the keyboard to discard any previous lighting and to

Highlight key number 2 in color 0
Highlight key number 3 in color 1
Highlight key number 4 in color 2
Highlight key number 7 in color 3
Highlight key number 10 in color 4
Highlight key number 11 in color 5

The remainder of the keys are not to be highlighted. In this system, the actual colors are taken from a predefined, fixed list of colors. For example, 0:blue, 1:green, 2:red, 3:yellow, 4:cyan, 5:orange. If the keyboard starts with a ‘C’, the corresponding pitches will be D, D#, E, G, A# and B, respectively. However, it would also be possible to have a system which downloaded the list of colors at the beginning or periodically as necessary or desirable.

In the embodiment of FIG. 1 mechanism 104 includes light emitting diodes (LEDs) or any other lighting source used to light keys 122a-122c in response to electronic signals received from the computer 102. In the embodiment of FIG. 2, keys 122a-122c are lighted by projecting light onto them through a projector 130. Projector 130 receives the image of the lighted virtual keyboard 108 from the display 106 and projects it onto the actual keyboard 120. The image of the virtual keyboard is aligned with the actual keyboard so that their corresponding keys coincide. The projector beam may be directed directly onto the keys or may be reflected onto the keys by a mirror. In other embodiments where multiple keyboards are used, multiple projectors may be used or a single projector with a multiple beam splitting. In yet other embodiments the beam of a single projector is separated into multiple beams with mirrors or prisms.

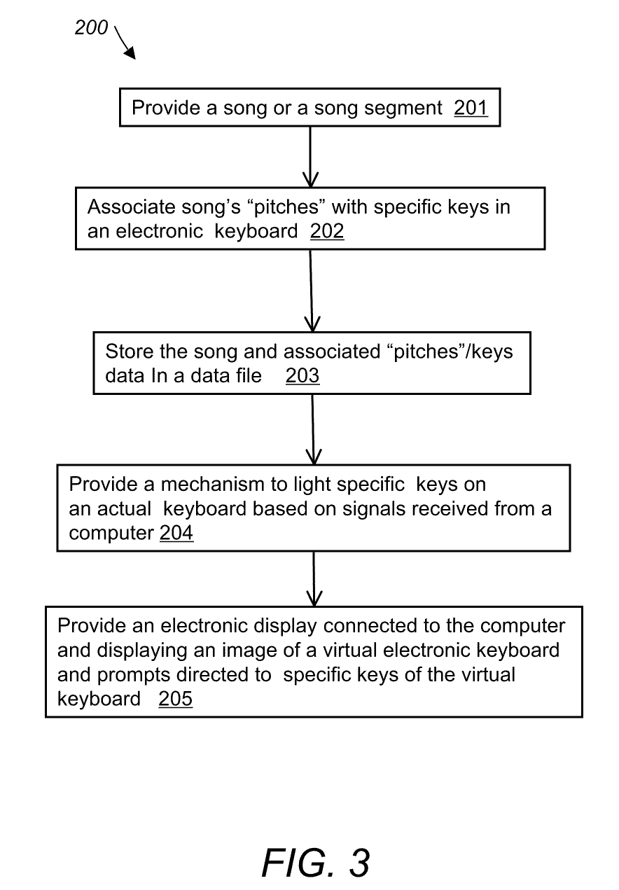

Referring to FIG. 3, the process of developing the game 200 includes the following steps. First a song or a song segment is selected (210) and the main pitches of the song or song segment are associated with specific keys in the electronic keyboard (202). The data that associate the song “pitches” with keys are stored in a data file (203) and a mechanism is provided for lighting specific keys on the keyboard based on signals received from a computer/controller (204). An electronic display is also provided that receives signals from the computer and displays an image of a virtual electronic keyboard and prompts directed to specific keys of the displayed virtual keyboard (205).

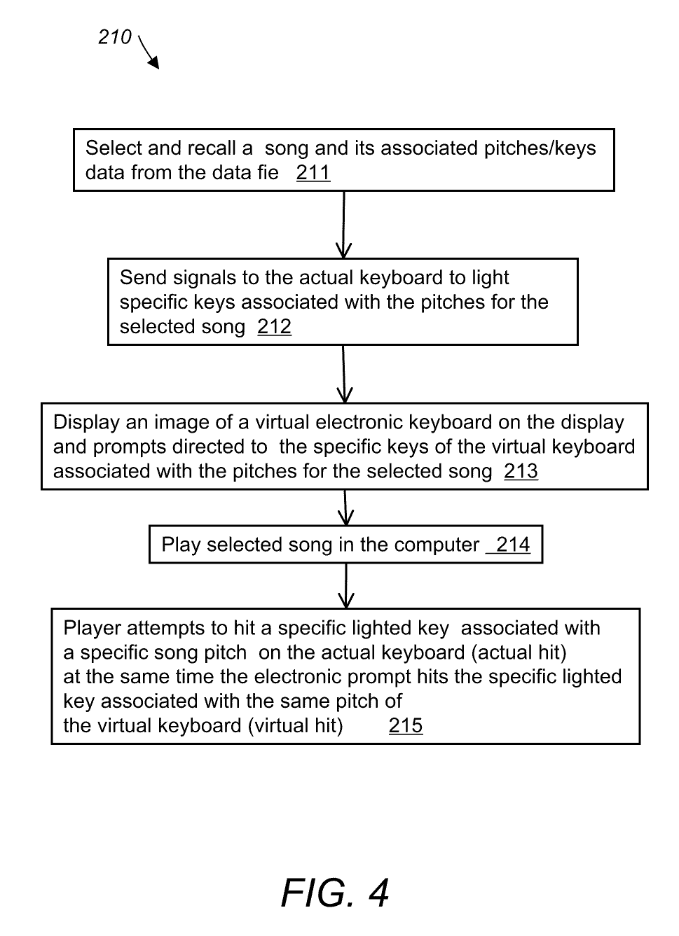

Referring to FIG. 4, the playing of the game 210 involves selecting a song and recalling the song and its associated pitches/keys data from the library (211). Next, the computer sends signals to the electronic keyboard that activate lighting in specific keys that are associated with the pitches of the selected song (212). Each key is lighted with a different color. The image of a virtual electronic keyboard is displayed on the display, as well as prompts directed to the specific keys of the virtual keyboard associated with the pitches fort he selected song (213). Next, the playing of the song on the computer/controller is initiated (214) and during the playing of the song the player attempts to hit the specific lighted keys on the keyboard that are associated with the specific song pitches that are played (actual hit) at the same time the electronic prompt hits the corresponding specific lighted keys of the virtual keyboard (virtual hit) (215). The player is rewarded based on the timing and duration of the actual hit as compared with the virtual hit.

Referring to FIG. 5A and FIG. 5B, examples of song segments used in playing the interactive game 100 include the synthesizer part of the song “Whip it” by Devo 500 and the “bomp bomp bomp” ending in the song “Sweet Caroline” by Neil Diamond 510. The concept of a song segment, as used here, means a musical “part” played by one or more instruments or voices for part or the duration of a musical selection.

The division of a song and its vocal and instrumental parts into song segments is arbitrary. A person or process breaking a song into song segments can make choices to please the needs and abilities of an intended audience, opting to try to keep the number of pitches used near or below a particular number. In one example, a simple automated process, could decide to use 16-bar segments of tracks in a Musical Instrument Digital Interface (MIDI) file for the song segments. In other examples, the division of a particular song into song segments, either manual or automated, takes into consideration aspects of the particular songs in a more detailed manner. In one embodiment, represented by the examples above, the number of keys used within a song segment is kept around seven. In other song segments the number of keys used is between three and eleven keys. This requires skill and discretion in choosing the song segments. Once, the song segments are defined, each segment can be seen to include certain pitches and not others. This defines how the song segment will appear and be used on the keyboard.

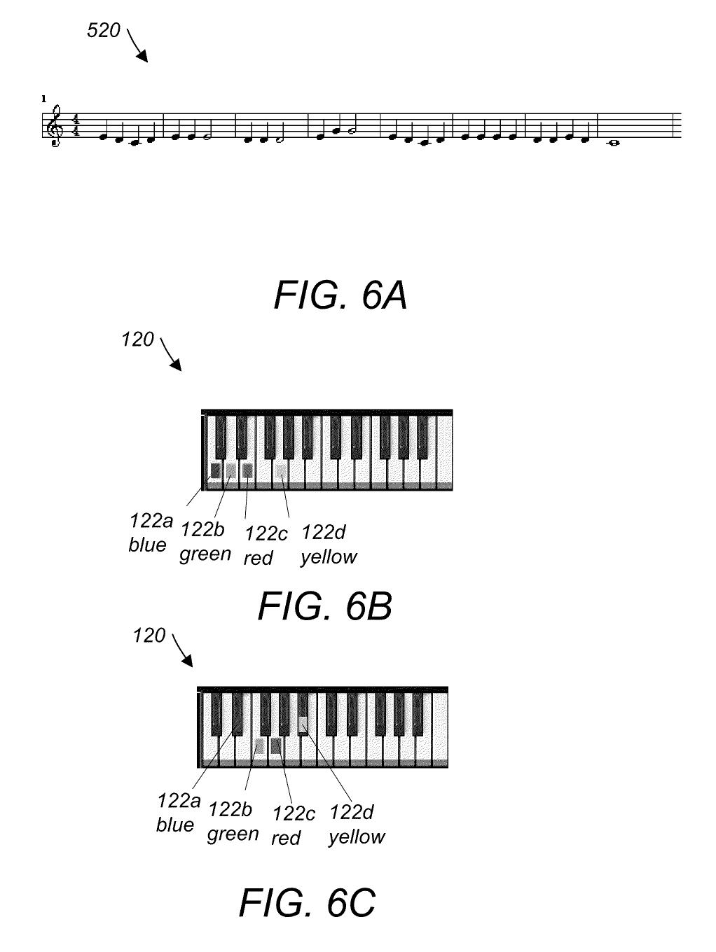

A song segment may contain a certain number of pitches, some of which may be played more than once. In one example, the melody to “Mary Had A Little Lamb”, as commonly played, has four different pitches, but all are used more than once, as shown in FIG. 6A. This concept is similar to what would occur on one line of a music score for a certain amount of musical time (possibly the entire selection), as may be measured in musical beats or measures or by Musical Instrument Digital Interface (MIDI) ticks or other timekeeping system.

It is not necessary to perform the song segment in the original work with the same type of instrument used by the player. For instance, a keyboard could be used to play a vocal melody line, a synthesizer could be used to play a brass line or a guitar lead, a guitar could be used to play the notes of a string section line, among others This type of substitution often happens in real musical ensembles, so it is not even unnatural to do it here.

The song segment may contain more than one pitch played at a time. For instance, it may be a left or right hand part of a piano selection. Alternatively, the pitches played by both hands maybe considered together as the pitches of a song segment. Although, as we shall see, there are advantages to defining the song segment in such a way as to include a limited number of pitches, that restriction is not included in how we are defining a song segment.

It might even be played by more than one instrument or player if, in the mind of the listener, it might meld together into a musical concept. For example, a set of tympani is a set of individual tuned drums that are physically independent from one another, but the melodic line produced by using all of these drums together might be considered to be a single song segment. In another example, classical composers at times have written melodic lines that run from the violins through the violas ending, for instance, on the cello. The composer may conceive and the listener may hear this as a single melodic line, even though it is played serially by different players on different instruments. The part played by the player may be transposed from the original. It might even be simplified from the original.

As was mentioned above, the keyboard 120 has some means to highlight a set of keys on the keyboard (or fret positions on the fretboard). Though it is of some use to highlight all of them in the same way, greater benefit can be obtained by varying each highlighted key in a different way. For example, on a keyboard with lighted keys, the non-highlighted pitches might be unlit and the highlighted pitches lit. Though it is of some use for them to be all one color, it would be a functional improvement if more than one color were used and better still if each color used was unique and easily distinguishable.

For instance, using the “Mary Had a Little Lamb” example in the key of C, the pitches would be C, D, E and G from lowest pitch to highest pitch. We might light them respectively blue, green, red and yellow 122a 122b, 122c, 122d, respectively, as shown in FIG. 6B. Alternatively, if only two colors were available, we might light them bright green, bright red, dim green and dim red. Alternatively, even simply green, red, green, red if necessary, referring to them when necessary as lowest green, lowest red, highest green, highest red. If they were all one color, they could be lowest selected pitch, 2nd lowest selected pitch, 2nd highest selected pitch, and highest pitch. It is desirable to easily distinguish each pitch uniquely, but some benefit can be derived when designations on selected pitches need to be duplicated or even in simply being able to very quickly distinguish the current selected pitches from those not selected.

Using the four color representation, one could think of “Mary Had a Little Lamb” as red-green-blue-green-red. However, on keyboard 120, not every key is colored. In fact, all of the keys which are not selected are not colored or colored the same or identified by some unique changeable characteristic. The keys that are used are colored, as was described above, and remain colored during the entire duration of the song segment. Therefore at a glance, the player can tell which keys do not have to be considered for a song segment and which ones will be used. The keyboard 120 ideally illustrates this for all the keys even before the playing of the song segment begins. This allows the player to quickly consider how to place his hand or hands, or feet for a pedal clavier, in such a way as to be able to easily and quickly access those keys, ideally even before the playing of the song passage begins. This described the concept of the “focused” keyboard.

This is very different from approaches that indicate one or sometimes more notes on a keyboard or on a keyboard representation just before they are used, such as Piano Wizard or Synthesia. In these prior art cases, the keys have all the same or different colors and there is not any form of constant highlighting of the keys used in the song and, more importantly, constant non-highlighting of all the keys not used in the song, even when they occur physically between keys that are used, such as the F in “Mary Has A Little Lamb”.

In the focused keyboard 120 of this invention, it would be considered functionally better if the same colors were used. However, the present approach does not use one color for C's, another for D's, and so on. Instead we use one color for the lowest note actually used in a particular song segment, another for the second lowest note actually used, and so on. Therefore, if we use a different song segment, or a song segment played on a different key, we may use the same colors, but they will generally be on different keys since the keys used by the new song segment or the song segment played on a different key would be different. In the example of FIG. 6C the song segment of “Mary Has A Little Lamb” is shown played in D-#(Eb) key and the pitches would be D# (Eb),F,G and A#(Bb) from lowest pitch to highest pitch. We light them again as blue, green, red and yellow 122a 122b, 122c, 122d, respectively, but are on different keys than in FIG. 6B, where it was played in the key of C major.

It is possible that a song segment might encompass an entire song from start to finish, such as in “Mary Had A Little Lamb” above. However, in many cases, more than one song segment may be used in succession. For instance, there may be one song segment for the intro, one for each verse, one for the first part of the chorus, one for the remainder of the chorus and one for the ending. Since it is desirable to have not more than a few pitches in each song segment (for example, less than twelve and, preferably, no more than six), in complicated musical passages or those involving chords, it may be desirable to change to a new song segment quite often, sometimes even within a measure.

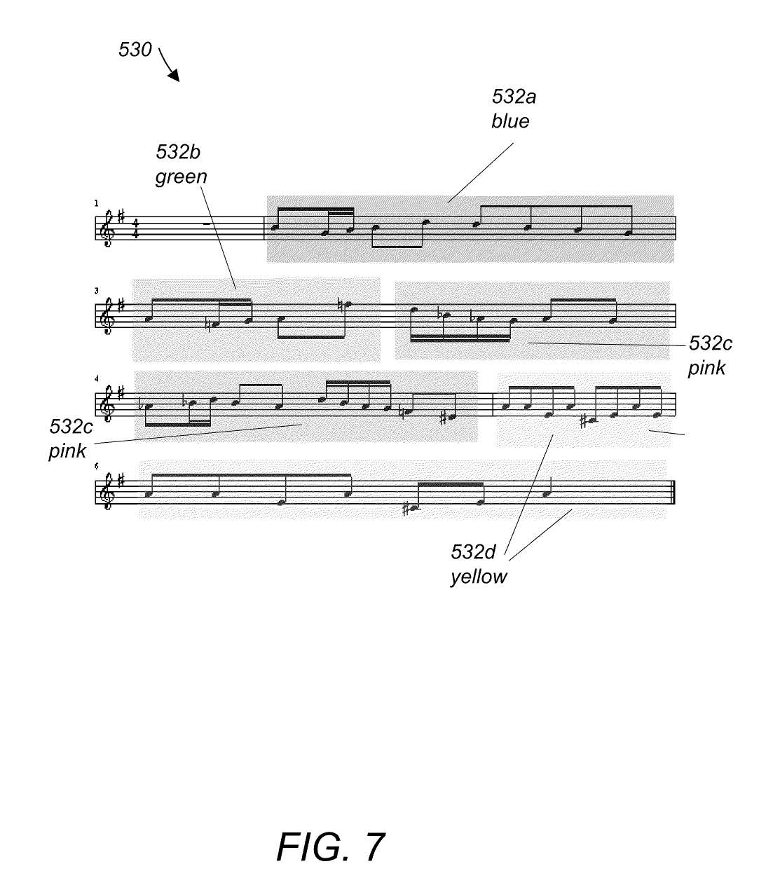

Referring to FIG. 7, in an example from the organ intro to the Doors' “Light My Fire” there are four song segments 532a (blue), 532b (green), 532c (pink), 532d (yellow). The colors used are to distinguish one song segment from another and do not relate to the keyboard color lighting. For each of the four song segments, the keyboard lighting may respectively be 531a, 531b, 531c, 531d, as shown in FIG. 8. The coloring strategy here is to assign colors consistently from left to right. As shown in FIG. 8, the same key does not always have the same color though out the different segments.

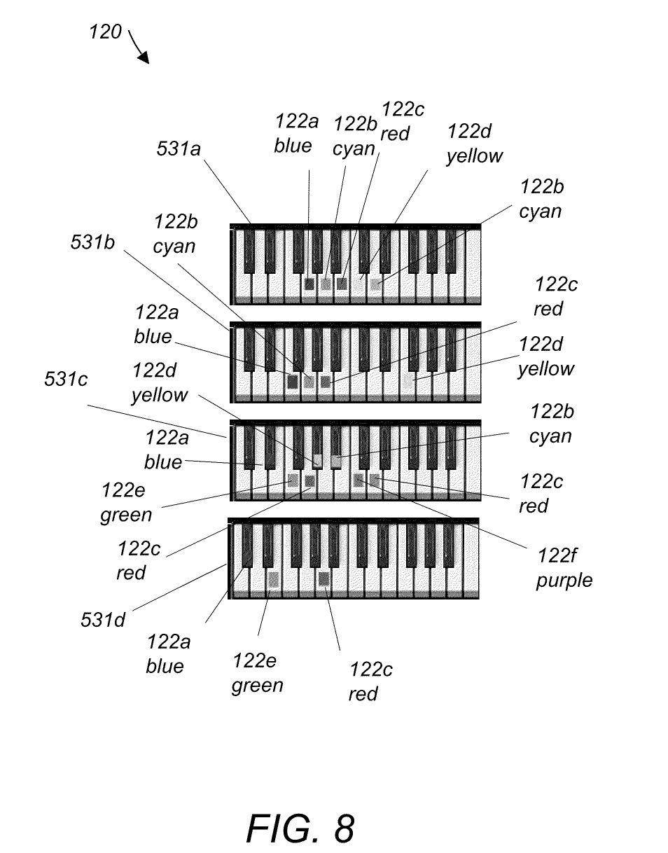

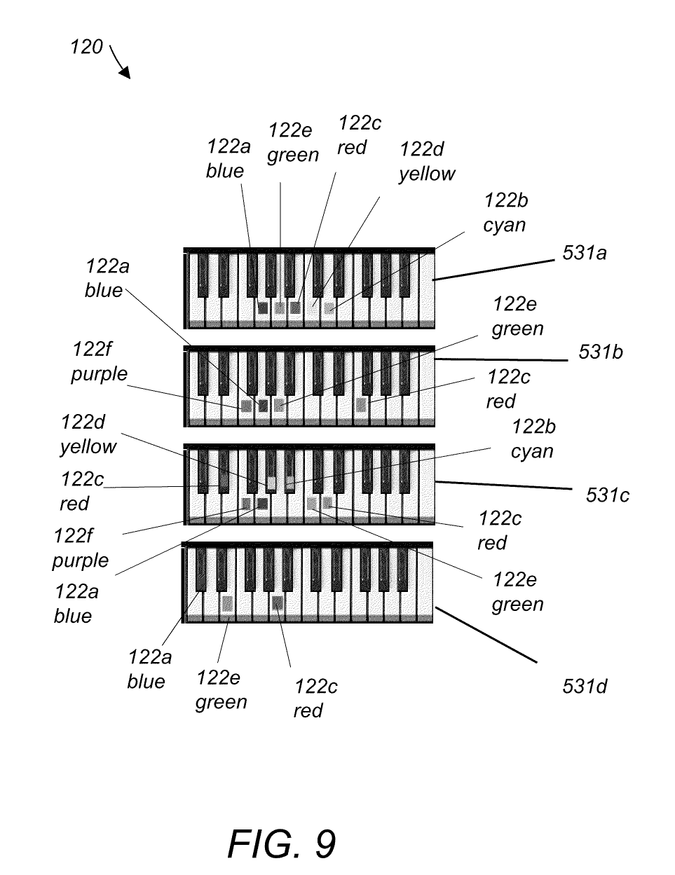

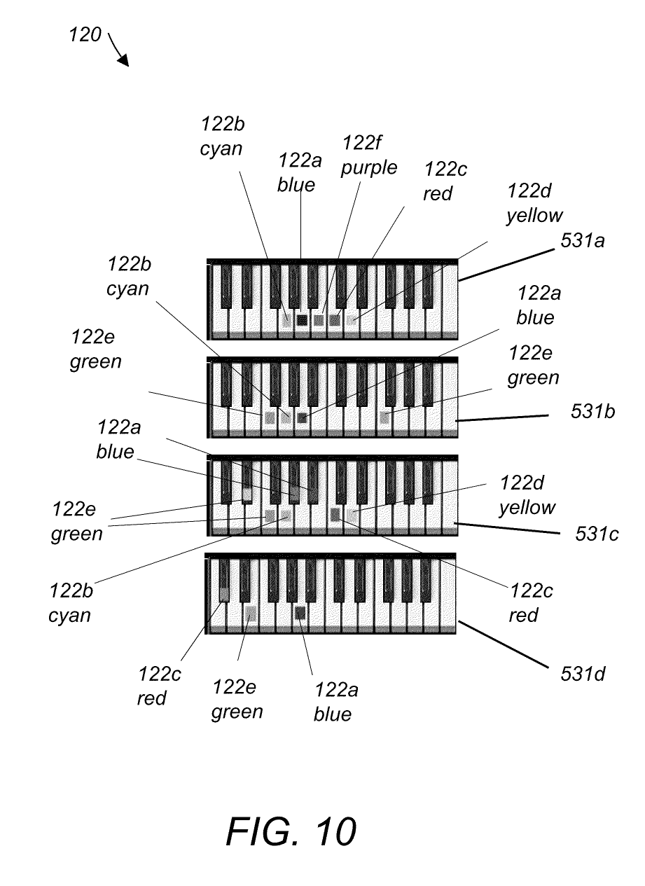

Many alternative coloring strategies can be accommodated by the focused keyboard 120. Referring to FIG. 9, here is the result of a strategy that keeps a key the same color if it appears in two successive song segments. However, even in this strategy, a color is not constantly associated with a key or pitch name. For instance, the ‘A’ is green 122e at the start 531b and red 122c at the bottom 531d. In other embodiments, the focused keyboard 120 may employ a strategy in which each pitch remained the same color with the colors perhaps chromatically assigned. That would result in something similar to the set of pictures 531a-531d, shown in FIG. 10.

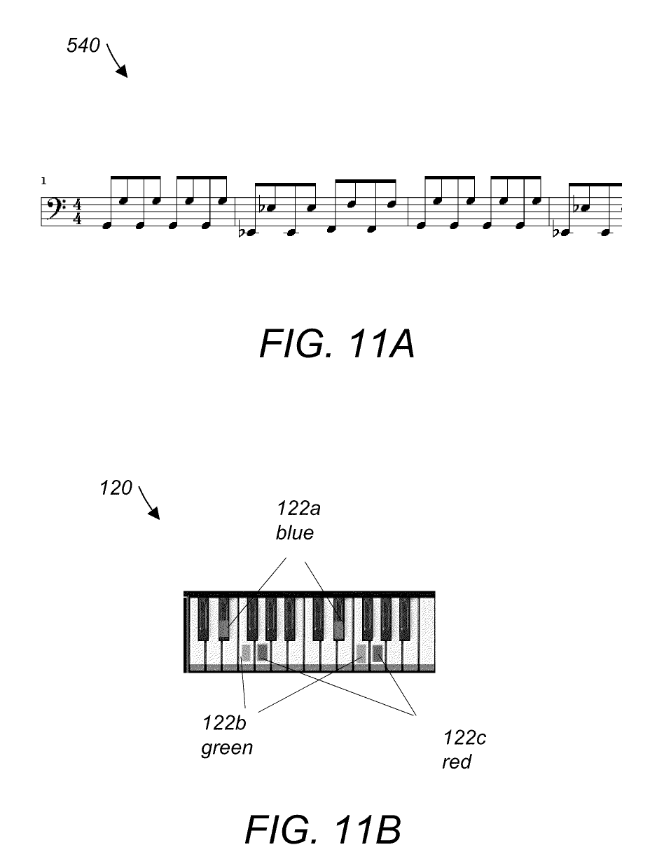

A focused keyboard's 120 color (or other designation) selection could in some cases be set up specially for something highly dependent on the particular song segment, for instance making things easier to grasp by capitalizing on some symmetry in the music. Referring to FIG. 11A, a passage played on bass synthesizer in U2's pop song called “Two Hearts That Beat As One” 540 is represented on the focused keyboard 120, as shown in FIG. 11B. Here there are duplicated colors (which is usually a disadvantage), but in this case they simplify the situation for the player. If the player decides to play with two hands, the player can see how to place the two hands and guess that they will be led to play notes in similar ways. Even if the player uses only one hand (as would be done in more professional situations), the layout in this case still helps to explain how the notes are used in this case. If this were played with the left hand, a professional would generally use the thumb on the right three notes and other fingers for the lower notes, possibly just the little finger, given the nature of this example. In any event, the focused keyboard 120 helps the player to quickly see what is expected in performance.

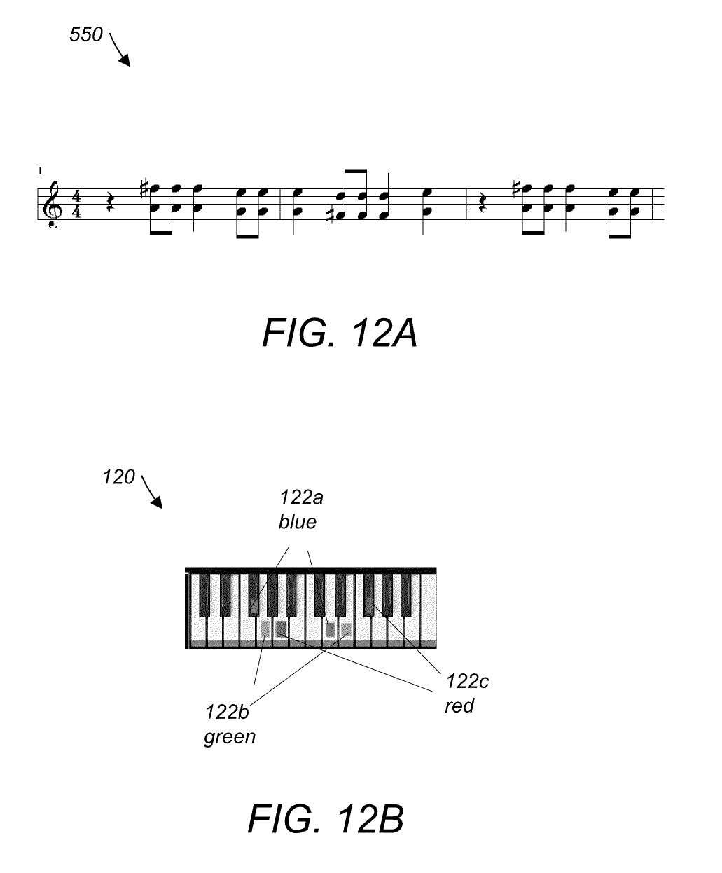

Referring to FIG. 12A, and FIG. 12B, in the example from the marimba part of Roy Orbison's Blue Bayou 550, there's a similar usage, but in this case identical or similar colors are used to cue the user of keys that will be played together, even though they are not the same pitch name.

There may be circumstances that make one scheme preferential over another, such as cost considerations or a principle in a music lesson being taught. For example, the scheme of FIG. 12A, FIG. 12B, has the advantage that each key need only display one color. For instance, twelve distinguishable shades are needed and similar shades are on adjacent keys where, perhaps, contrasting colors would be preferable for quick recognition, particular if coordinating with rapidly moving colors on an associated computer display. Also, there are only four notes highlights, but two of them are F's and therefore have the same color. Also note that in the first scheme shown in FIG. 11B, if one is playing the song segments with right hand only, positioning one's thumb on the blue note quickly starts the user towards what is often a favorable hand position for that particular song segment. The user would get used to associating ‘blue’ with the lowest note. Yet, adjacently used notes have contrasting colors whether they are very close in pitch or not.

The controlling software or hardware 150 used with the focused keyboard 120 may always consistently use the same approach to key coloring. Alternately, it may use different strategies at different times, either chosen by the user's preference or chosen within the usage context, for instance, keeping pitch colors the same when pitch-oriented lessons were given and keeping the color for the thumb key the same when teaching lessons about fingering.

Ideally the game or other mechanism allows the player to first work with each song segment individually, possibly even allowing it to be slowed down or advanced a note at a time. In this way, when the song segments are used together and the highlighting changes (ideally as the last note of the previous segment is being played), the user is ready and expecting the “focus” change since the user has already played the song segments individually. In another possible embodiment, a focused keyboard 120 or fretboard is used without playing with recorded sounds or even trying to play in rhythm. In this case, the focused keyboard 120 helps the player to only focus on the keys used for the particular passage.

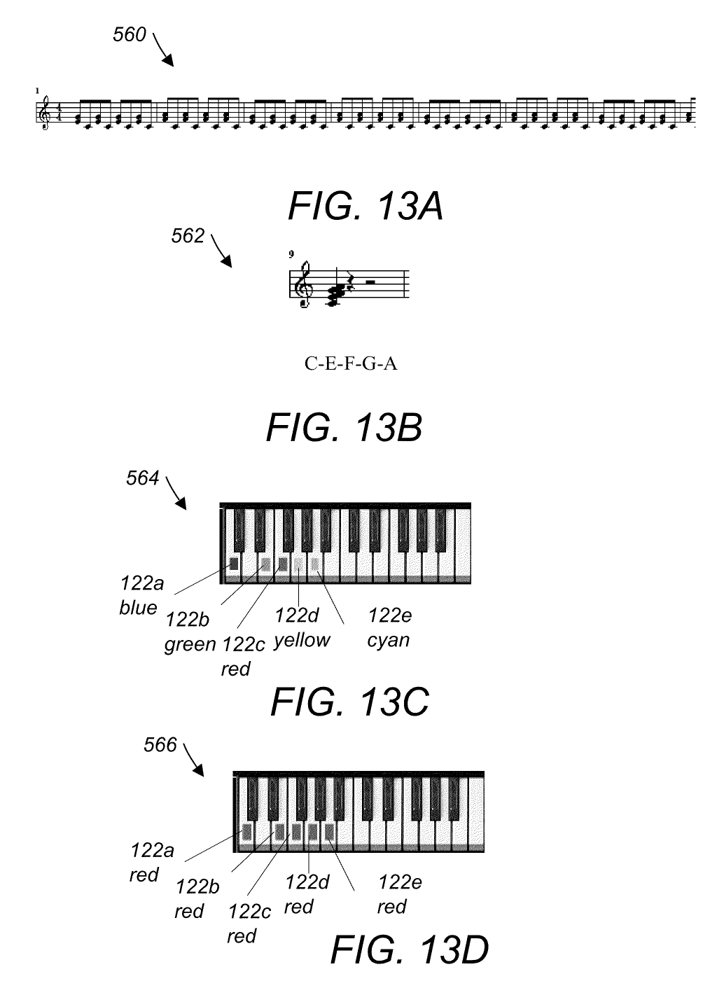

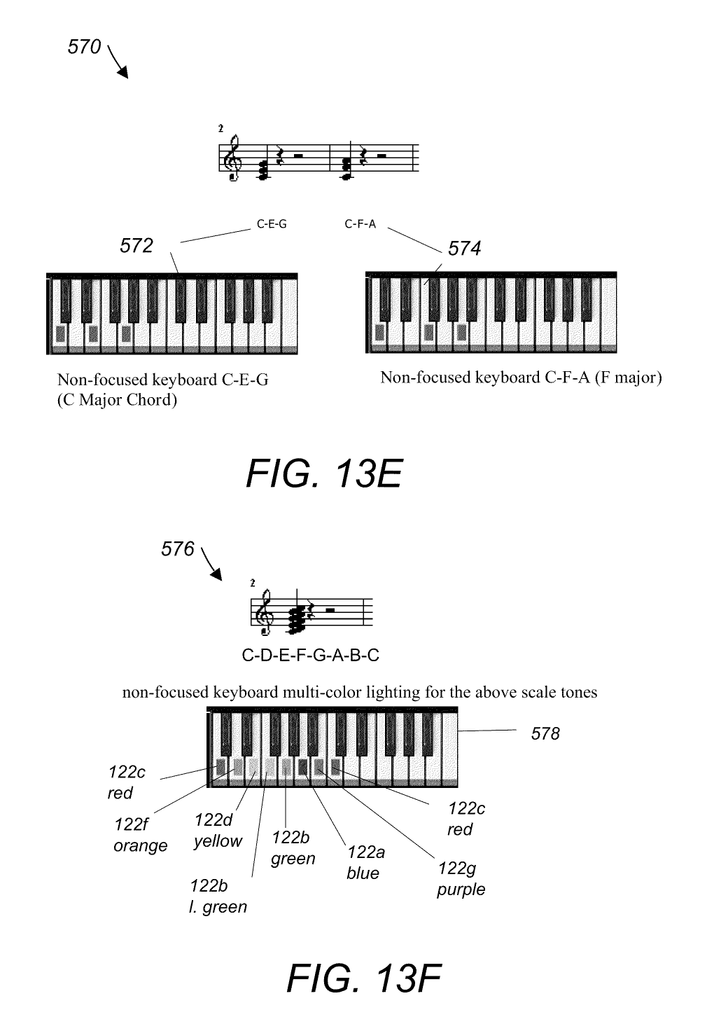

The present system doesn't lead the user through, note by note. Instead, in system 100 the notes actually played during a song segment are highlighted, whether or not they are a part of a particular chord or scale. Rarely this might coincide to come up with the same set of keys, but usually it would be quite different. This is because many of the song segments are melody or counterpoint lines and these usually do not simply follow the notes of a chord or scale up and down. In one example, a song segment covers a chordal accompaniment pattern that includes playing a C and F chord, possibly in “broken fashion”. The notes of the C-chord are C-E-G, the notes of the F-chord are C-F-A and the notes for the entire C-Major scale are C-D-E-F-G-A-B-C. The highlighting of the notes on the keyboard is based on the notes that are actually played in the song segment, i.e., C-E-F-G-A, as shown in FIG. 13B and FIG. 13C. This is neither the notes of a chord nor the notes of a scale.

Expanding further with a musical example, a simplified right-hand accompaniment pattern to John Lennon's “Imagine” is shown in FIG. 13A. Here we have included about twenty seconds of a useful musical thing to play and will only need to highlight five notes to cover that duration. Anybody will easily understand what is being indicated and how to play it and most will succeed, in this case even at full tempo, within a few tries of playing. Even without any background recording, the playing of this song segment at the tempo of the song with a piano sound is distinctive enough that many listeners might quickly identify the song as John Lennon's Imagine. That's unusual considering that the player may not have any real musical experience, but it seems to be a common occurrence with song segments learned from the game in this style. On the focused keyboard instrument 120, the keys for these pitches C-E-F-G-A are highlighted because these are exactly the ones included in the above song segment, as shown in FIG. 13B. Ideally, each of these keys 122a-122d is lit in a different color, i.e. C-blue, E-green, F-red, G-yellow, A-cyan, respectively. These color selections depend on the song segment, not the note name of the key, i.e. C's would not always be blue every time they are used in a song segment. A different song segment may likely result in a different color for ‘middle C’ (the lowest note in this example) if it happened to use ‘middle C’. In the example of FIG. 13D each of these keys 122a-122d is lit in the same color, i.e. C-red, E-green, F-red, G-red, A-red, respectively. The keys that are not used are not lit.

In contrast, a non-focused keyboard which highlights chords, may display the left group of notes 572 for the odd-numbered measures C-E-G and the right group of notes 574 for the even measures C-F-A, shown in FIG. 13E. FIG. 13F depicts the notes in a scale-oriented non-focused keyboard 578, even though ‘D’ for example, is not used in this song segment. In summary, the focused keyboard instantly shows the player which keys will be played during the song segment and which need not be considered at all, thus showing the player where to focus his attention.

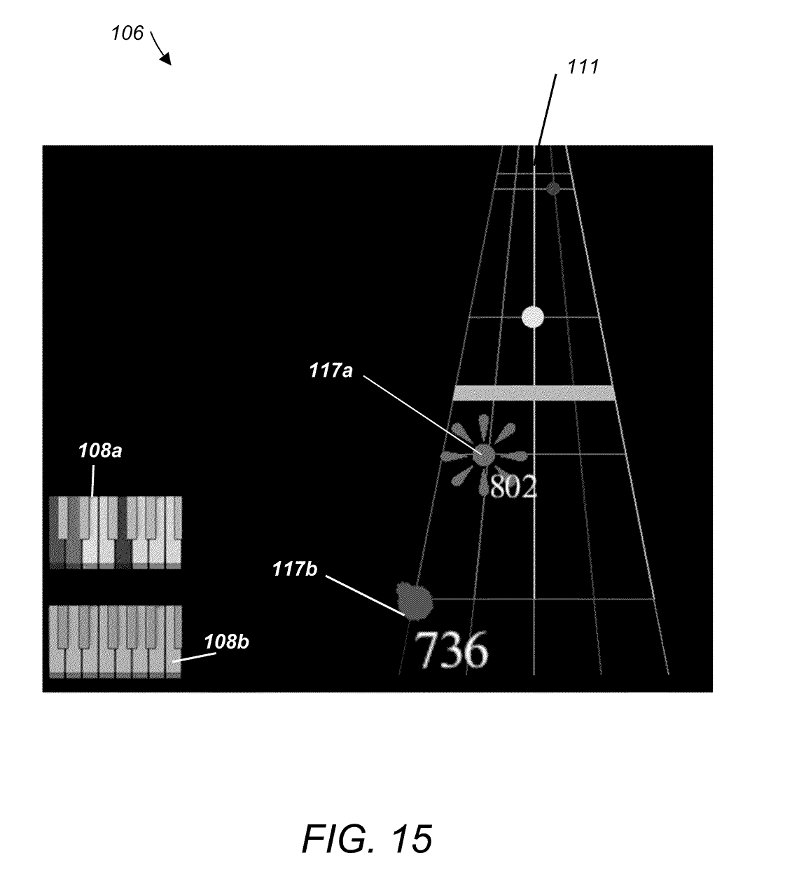

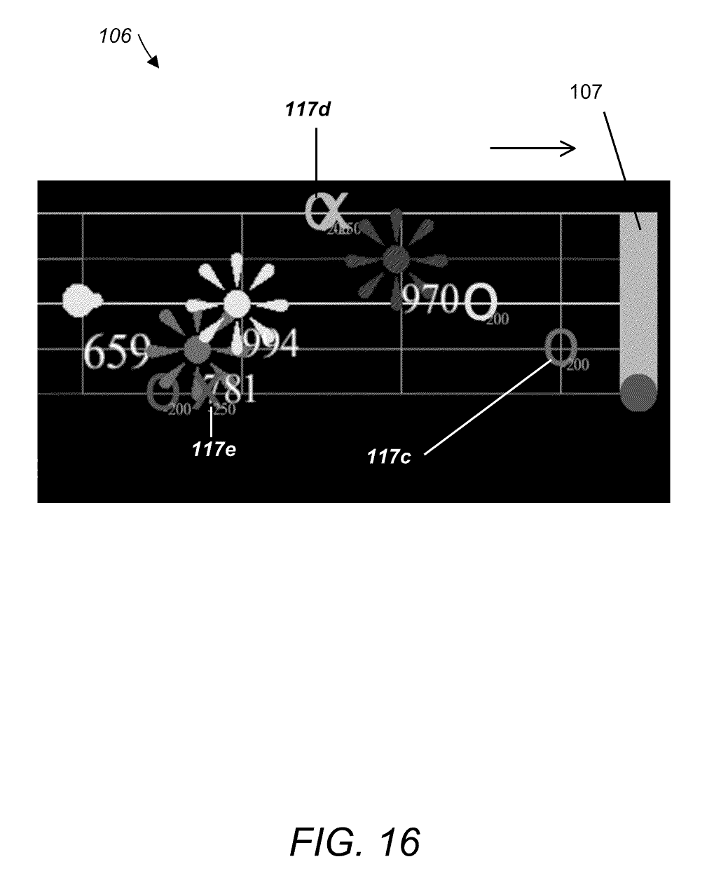

The scoring of the game is described with reference to FIG. 15 and FIG. 16. Each note can be worth up to 1000 points if it is played accurately. Accuracy is judged both in pitch and in time. A slightly wrong note played at the right time is worth approximately as much as a right note played at a slightly wrong time. If a note is neglected entirely, in the current implementation it turns into an open circle ‘O’ 117c when it becomes too late to play. If “extra” notes are played that cannot be matched well enough with any note in the song, an ‘X’ 117e appears on or between the lines showing this added note played. The software is programmable as to how close a note must be in time and pitch to be a possible match. At most, each song note can only be matched once. If it seems to have been attempted more than once, the game attempts to match it with the best match and the remaining notes are considered to be “extra” notes and result in a penalty, similar to the penalty for notes missed entirely.

If a note is matched pretty well, it results in an explosion 117a, as shown in FIG. 15. This note was close to ideal, but perhaps off by a few milliseconds, so it scored 802 out of 1000 in this implementation. If a note is matched, but not particularly well, a tail 117b of various sizes is drawn on the note, as shown in FIG. 15. In this case, the direction of the tail indicates that the player played a note with a slightly lower pitch and played it slightly late. This note was therefore not as good as the previous one (117a), but still close enough to get 736 out of a possible 1000 points. In other embodiments scoring scales with a different maximum point are used.

Referring to FIG. 16, in another embodiment the target bar 107 moves and the notes do not. It is also a horizontal, non-perspective mode, though those attributes are not necessarily associated with the target bar moving instead of the notes. In the case shown here, the target bar 107 moves from left to right and a short song segment has just completed. One advantage of this particular mode is that it is easy for the user to look back after the end of the song to see exactly what happened. In variations of this mode, we alternate between two or more sets of lines, similar to going from one line to the next in sheet music. That allows more notes to be displayed at a time than would easily fit on one line and also makes the rhythm clearer to the player. The “alpha” 117d scoring notation is actually superposition of a missed note scoring notation ‘O’ 117c followed by an extra note scoring notation ‘X’ 117e. The criteria for whether a note is a good enough match could be altered by user preferences and also by such factors as the speed and difficulty rating of the particular song.

Game 100 is able to accurately match and score notes in real-time, as fast as they are played. Prior art games may appear to do a similar thing in their scoring, but there is an important difference. While prior art games may allow graduated scoring for notes (or steps) that are slightly off in time, they do nothing that compares to graduated scoring for notes that are different but close in pitch. In the present game, any of the twenty-five keys on the standard two-octave keyboard might be pressed at any time, whether lit or not and partial score and matching will be considered for even unlit keys that are played at nearly the right time as the lighted note. Therefore, the present game compares and matches keys played based on time and pitch rather than just on time.

Since this is a music game, what the player hears when playing is of paramount importance. There is actually some flexibility in what sound is offered. Because the audio sounds from the recording closely match what the player is playing on the game keyboard, the player feels as if he is part of making the sound. This can be the case even when the sounds heard do not reflect or include what the player is doing at all, particularly if the player is doing well. A similar situation can happen with real musicians in a group. If one is playing clarinet in a concert band with a lot of clarinets and the nearby other clarinets are playing the same part, it can be hard to discern one's own playing and even if one stops playing, it may not sound that much different. All the parts playing the same notes blend in together and it is difficult to discern the instruments individually. Comparably, if the sound played from the player's keyboard is very similar to the sound on the recording and he is doing well at playing the same part with the recording, he may feel as if he is hearing himself play, even when only the recording is being heard. This effect is strengthened by the fact that the ear hears sound intensity in a logarithmic way. When two instruments play instead of one, the combined sound is three decibels louder, but that is not heard as a doubling of the sound volume.

There are situations in which the player might really want to blend in well and wants the sound of his own “instrument” to closely match the sound qualities of the associated instrument on the recording and wants to hear his part only quietly or not at all. For instance, when showing off for friends, one might want to sound just like the player in the recording, be heard distinctively a little, but not be too obvious when wrong or mistimed notes were played. On the other hand, when the player is alone and seriously wanting to do better, he may want to be able to hear his part clearly and distinctly by having it loud compared to the recording and possibly of a somewhat different tone quality. For example, the recording may be using an electric piano sound but the player chooses to hear a different and distinguishable model of electric piano (such as Wurlitzer-like instead of Fender Rhodes-like) or even chooses to hear his playing with an acoustic piano or perhaps a marimba sound. This can be very helpful when learning, since the player can relate to both the similarities between his playing and the audio track as well as the differences. Another effect that can be controlled by the computer and used separately or in combination with this is to play the players part and the recorded part in two different places spatially, for instance the audio track in the left stereo channel and the player in the right stereo channel.

In cases where the game is using an audio recording in which it can separate the instrument that corresponds with the player from the other instruments in the recording, there are even more useful possibilities. For instance, the corresponding instrument in the audio track may be dropped altogether, leaving only the player playing that part in the result.

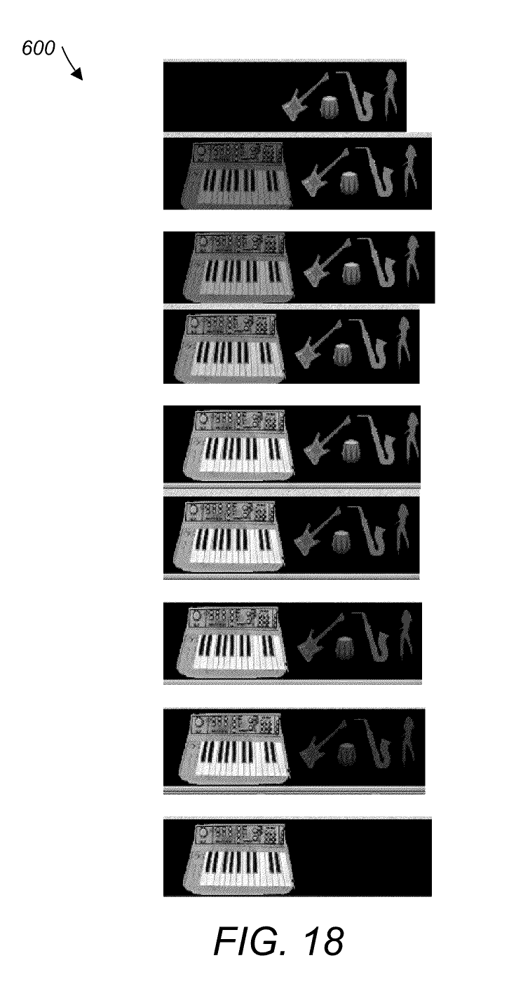

If the player can control the mix, he could also turn the audio recording off altogether, only hearing his own playing. A player might also find it fun, interesting and useful to remix the levels of the instruments and voices in the recording, to the extent the audio recording made it possible to do so. In the current implementation, the player can change the mix between game audio and his own playing at any time. On the screen, the player can see the current mix represented by the brightness of the keyboard icon compared to the brightness of the band icon, as shown in FIG. 18.

In one embodiment of game 100, there is an audio track (stereo pair of tracks, actually) that contains what the player is to hear during the game. Most often, this is the original audio of the song, as performed in a well known version by the creating artists without modification. This is one reason why players and bystanders seem to love the sound of the game. In some cases, this audio is slowed down or even slightly speeded up for the benefit of game ease or difficulty. In other cases, this audio may be transposed (pitch changed) so that the player's part on the often two-octave keyboard might correspond properly to the notes. The only sound that is added in this case are a few “lead-in” beats that alert the player that the audio is about to begin. The sound of these metronome-like lead-in beats is generally percussive in nature, though it could be a voice (“one, two, three, four”) like a band leader. currently the game uses one hi-hat cymbal sound for the downbeat and another for the other beats in the lead-in, though other prototypes use bongo sounds or other instruments.

An alternative to supplying an audio track in the above manner is to supply MIDI-tracks (played through some MIDI-compatible synthesis method) or a combination of the two. One advantage to the audio is that it sounds more natural to the player and avoids the need to supply software and/or hardware to play the described MIDI-tracks. In one embodiment, the above-mentioned audio and the generated lead-in beats is all that the player hears during the actual playing of the song during the game. Between songs, the keyboard does other things, as described elsewhere. When the audio needs to be slowed down excessively, it may sound unrealistic and even grotesque. In these cases when a usable and pleasant slowed down audio track is not available, it may be preferable to substitute with a MIDI equivalent. That does require the presence of MIDI software or hardware within the system or external to it which might not be necessary otherwise, since the simple lead-in beats can easily be done by other means. Another possibility to support playing very slow (typically less than 50%) of the original tempo is to use alternate audio tracks specifically designed to be slower performances of the same songs. These might be recorded by the original artists or by others.

There are other aural things that can be played along with the playing of the song. The existence, strength and mix of these might be determined as a player preference or fixed values might be tested and built into the game. These possibilities include:
Hearing what the player is actually playing on a similar or dissimilar instrument. A similar instrument blends in better. A dissimilar instrument makes it easier to hear the differences between what the player is playing and the actual part in the song. Either may be a good choice depending on circumstances. In some embodiments, we have played the player's part in a different octave to make it similar, but distinct that way.
Hearing the desired part played on a synthesized similar instrument. In this case, audio may be used that deliberately does not include the part of the desired instrument, which might require audio specially produced for the game.
Hearing a deliberately somewhat dissonant version of the desired track played if the player's performance has errors which trigger this. This “error” track could be accomplished in either audio or MIDI. After the player has met some criteria and/or after some delay has passed and/or after some new part of the song is reached, the playing of this “error” track would stop and the sound would revert to what it had been.
Hearing some rhythm parts made louder or with more emphasis in some or the entire song excerpt to make it easier to follow the beat, though with current music this seldom seems necessary.
Reinforcing or otherwise making the featured (often keyboard) part of the song more emphatic and easily heard, possibly by changing its strength or tone color or quieting or silencing less relevant instruments or voices.

There are a lot of possible choices here. They could be dictated by player preferences, considered preset choices, circumstances within the game or some combination of these.

In the embodiment of FIG. 1, while the song is not actually being played, the keyboard reverts to acting like a sampled keyboard, using a “sample” that is similar to the instrument part played in the previous or in the coming song. There are varying degrees of sophistication possible in sampled keyboards and which could be used to make this state of the game better. This embodiment uses the same sound across the keyboard, only changing it in pitch. Some sounds are looped, whereas others are not.

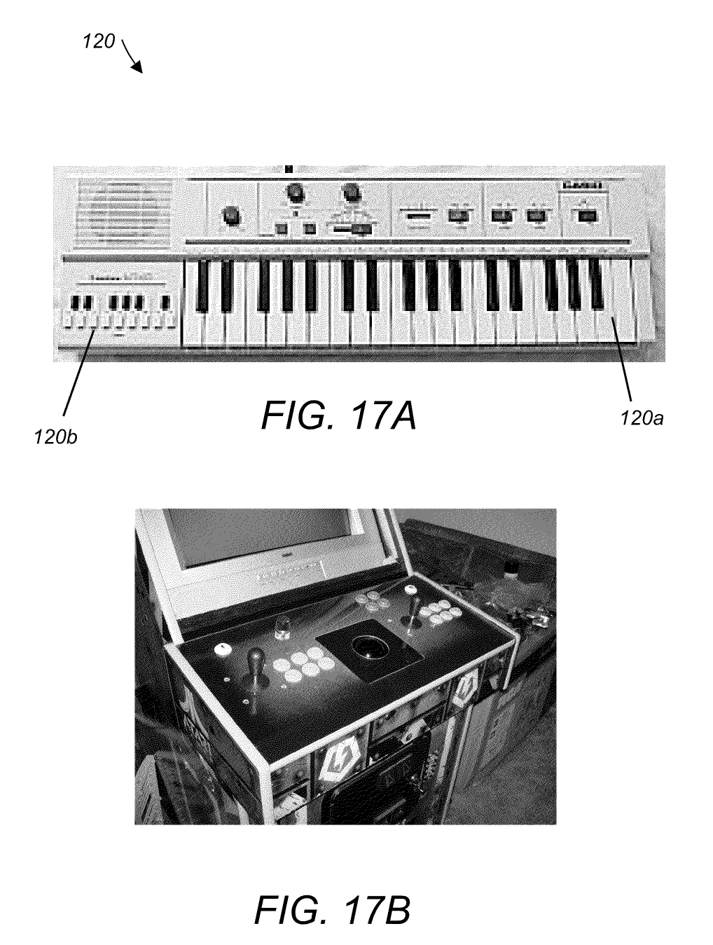

As was mentioned above, in the embodiment of FIG. 1, keyboard 120 is a 25 key C to C keyboard. In other embodiments, one may use a smaller or a larger keyboard. However, twenty-five keys allow very many song parts to be easily played without much modification. It is, of course, possible and somewhat desirable to have even more keys, but that makes the keyboard more expensive, especially if all the keys have all the lighting abilities and this makes the instrument bigger and heavier. Keyboard 120 in FIG. 1 has full-size keys, though there is nothing that would prevent the game from being played with keys of any size. FIG. 17A depicts two examples of non-full-size keys 120a, 120b as are common on smaller keyboards and even on some keyboard instruments, such as an accordion. Game 100 is not dependent on the size of the keys and any of these keyboard sized, along with other sizes, may be used. However, playing the game with full-size keys provides more realism and makes it easier to transfer any musical skills learned to other instruments. Keyboard 120b may also be limiting because it has only fifteen notes. Keyboards with limited number of notes, such as 120b, or keyboards using ordinary type buttons, are used in cases where a low cost instrument option is desired. The game automatically “transposes” the game music part to the octaves of the attached keyboard. So a keyboard used for a bass part on one song can play the high part on the next song without touching any buttons on the keyboard.

Referring to FIG. 17B, in an arcade version of game 100 with likely limited functionality, it might be more practical to light up fewer keys. In an application like this where durability and resilience to vandalism are important, the keys may even be large lighted buttons on a panel that only depress slightly or even touch sensitive lighted pads possibly flush with the panel surface. Arcade machines generally use ruggedized panels as shown in FIG. 17B. Nonetheless, suitable buttons or touch surfaces are arranged into a keyboard pattern and lit in multi-color style to implement an arcade version of game 100.

Some keyboards have small speakers built-in, as shown n FIG. 17A, and others do not. Almost all have a headphone jack and most have “line out” or “balanced line out” in mono, stereo or even quad to external amplification and recording devices. Some keyboards offer several power options. Any of these options are possible for a keyboard 120 for game 100, though none are mandatory. It is a matter of desirability vs. size and cost.

A minimum of four colors or other distinguishing mechanism would be desired for a reasonable game. If only a small number of colors were used, they could be repeated again in order on higher notes without adding an intolerable amount of confusion. However, the game works significantly better, when each key that is lit has its own color. In some embodiments, between one and nine colors per song excerpt have been used, but there is nothing magical about the number “nine” and more colors could be available and used on some songs.

From an electronic point of view, keyboard 120 (or any other musical instrument) signals the pressing of notes electronically to the game processor. It is highly desirable that it signals their release as well, but one could still have a good game without that feature. Keyboard 120 also accepts electronic signals telling it to make a particular key a particular color.

Other desirable features of game 100 include the following among others:
Having a small display could be useful as a means of communicating to the user, particularly if the keyboard supports usage away from the game system.
Having additional controls, such as the pitch-bend and tonal effect controls available on many keyboards could be used as an added feature in some games and in general add to the enjoyment of playing the instrument with or without the game attached.
Touch sensitivity and pressure sensitivity would be desirable and could be used within the game, but these are not necessary.
Having an internal sound generation system with speakers and/or an earphone jack would be useful particularly when the instrument is used away from the game.
If the sound generation system is based on samples (such as PCM) or other means of capturing an instrument sound, this is useful in making the keyboard sound like it is associated with the game even when it is disconnected from the game.
Appropriate batteries and/or ac power adapter would be necessary for use away from the game. The instrument could be powered that way when used with the game, but it might more likely be powered through the cable attaching it to the game system.
Wireless capability would add to the flexibility and enjoyment of the game.
The interface to the computer gaming system might be through a standard compatible with many platforms, such as USB, or some other standard could be used with the game possibly connecting in a different way to the gaming system.

Keyboard 120 may have a small amount of memory that would allow it to store the sounds of instruments recently used in the game and/or instruments in the game specified by the player. This will be useful in cases keyboard 120 is temporarily removed from the game. It may also have other built-in sounds as well. With enough memory and appropriate onboard intelligence, the keyboard 120 may even be able to download and store audio song samples from the game so that the player could play along with them even without the game. In some embodiments, the keyboard 120 incorporates the computer 102 and/or display 106.

Other embodiments of the invention may include one or more of the following. The keys in the focused keyboard 120 may be designated with shapes, numbers, letters, textures or type font size, instead of color. Another possibility is to reposition keys to show their status in the song segment. For instance, the keys not used could be slightly lowered. This may be done with or without another designation system, such as colored keys. The “prompting” display of the keys, as was described above, shows the keys used by colored dots arranged in order of pitch in one dimension and in order of times in the perpendicular or another dimension. These dots move towards a target position 107, as shown in FIG. 14 and FIG. 1. In other configurations the notes may be steady and the target bar 107 may move across them instead. The entire part being played could be represented by one continuous line of these musical notes or several lines could be used in sequence, proceeding to the next (or back to the first) when a line has finished playing. This is particularly useful in cases where the target moves instead of the notes because then it more resembles the idiom of sheet music. The colored lines 111 may be evenly spaced and instead of a model virtual keyboard 106 being pictured at the bottom, two keyboards may be pictured at the left as shown in FIG. 15. In this case the upper keyboard 108a shows which colors are for which keys and the keys on this keyboard may move up and down as the notes are played. The lower keyboard 108b in this case echoes what notes are being played on the player's actual keyboard 120 so that it is easily judged whether a correct key is being used. Alternately, the upper keyboard 108a could just show the colors and the lower keyboard 108b could show the timing of the notes, i.e. whether they should be up or down at the moment. A thin target bar 107 may be used on which the note should be played when it is centered, as shown in FIG. 15. An arbitrary scoring system may be used to score a game or even no scoring system at all. Scoring systems could give bonuses, for instance, for having played so many notes without error or for achieving, say, exceptional timing accuracy. Mechanism 104 may be implement via other means of transmitting music-related messages, such as XML, JSON or a proprietary format. Game 100 may be played without the actual instrument 120, but rather using the computer keyboard. Game 100 may also be played with a keyboard that doesn't light up by simply watching the lighting on the screen carefully and matching notes to the keyboard by comparing it by shape with the colored keys pictured on the screen. However, the ability to be able to match the notes on the screen to those of the physical color by color at any instant is something that gives particularly starting players confidence and security and adds a lot to the appeal and easy understanding of the game.

Furthermore, in other embodiments, two (or more) song segments for the same song are shown and used simultaneously together. For example, something with both a piano part and synthesizer part, as is common in Elton John recordings. Alternatively, it may be two or more synthesizers, or a piano and organ, or even two or more string, horn or vocal parts. Both parts are shown on the computer display or on two different displays or even on two displays in two or more different locations connected by wiring or some sort of network. Games/learning exercises that can be played in this setup include the following among others:

One player plays two parts on a larger keyboard, one with each hand. A third or even a fourth part could be played with pedals in the style of a classical organist or some synthesizer artists.

One player plays two parts with a hand on each of two keyboards. Again, adding pedal parts is possible. The players may use the game to work up to this complexity one step at a time.

Two or more players may each play one part on a larger keyboard or instruments.

Two or more players may each play one or more parts on separate keyboards or instruments.

Combinations of different instrument may be used, for instance, keyboard and fretboard. The fact that each part is presented in a focused manner to the player involved would help keep the complexity manageable, and this would, of course, very much be like real musicians playing together in ensemble.

Another variation is where two or more players are involved with the same song segment or segments. Some variations include:

The players alternately play the song segment in a competitive manner. They might use the same keyboard (or instrument) or they might each use their own, particularly if they were in different locations. It is also possible to set up a competitive situation if they are not playing the same song segment scenario and/or level, but to be fair one would have to handicap if the difficulties involved were different. Similarly, a handicap system could give a weaker player a chance to compete meaningfully against a stronger player. It would also be possible for a player on a keyboard to compete with one on a fretboard given a handicap system or other means to compensate, even though the ease of playing the part might favor one type of instrument over another.

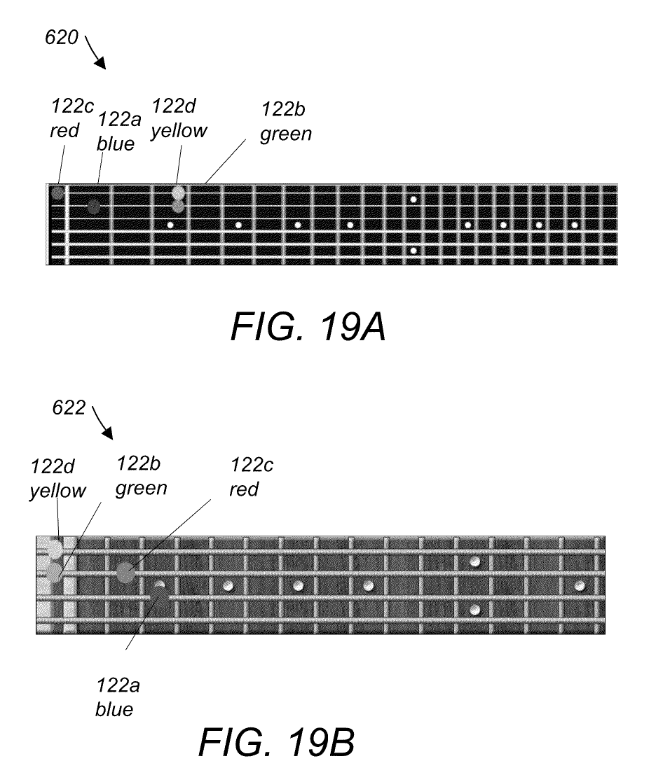

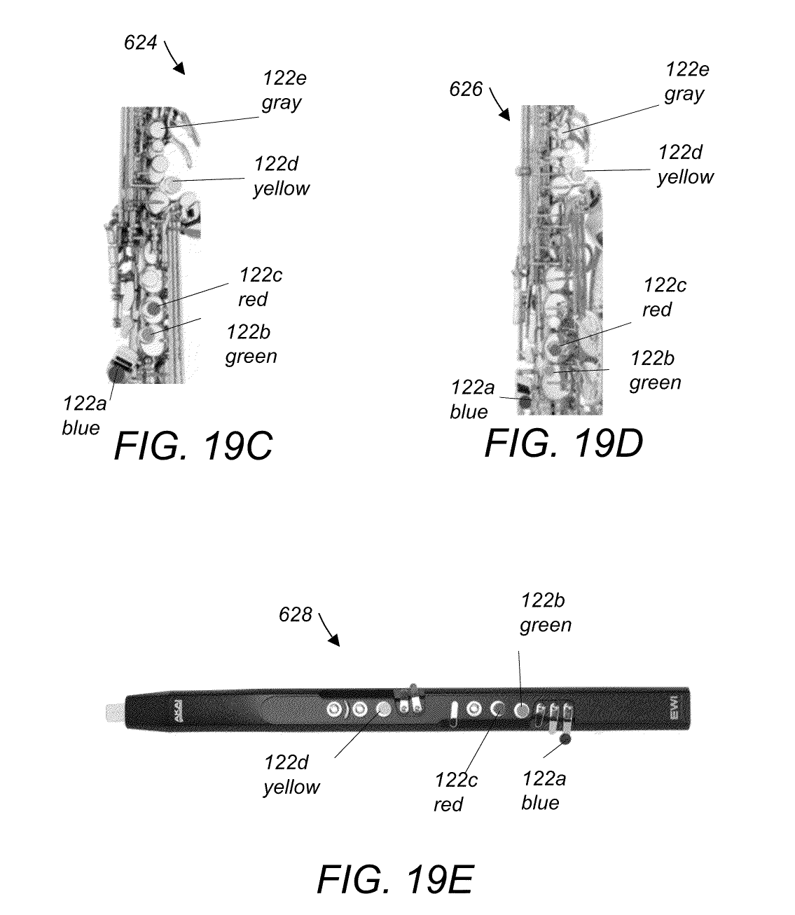

In other embodiments, instruments other than keyboards are used. They include guitar with lighted fretboard, bass guitar lighted fretboard, soprano sax lighted keys, alto sax lighted keys and EWI lighted keys, among others, as shown in FIG. 19A-FIG. 19E, respectively.

Several embodiments of the present invention have been described. Nevertheless, it will be understood that various modifications may be made without departing from the spirit and scope of the invention. Accordingly, other embodiments are within the scope of the following claims.

What is claimed is:

1. A game system comprising:
a real musical instrument comprising real keys configured to be manipulated by a player for playing music and thereby providing game input;
a computing unit communicating with said real musical instrument and comprising a database and a music application;
a display connected to said computing unit and configured to display a virtual musical instrument corresponding to said real musical instrument, wherein said virtual musical instrument comprises virtual keys corresponding to said real keys of said real musical instrument;
wherein said database comprises musical recordings and data specific to each musical recording that associate pitches of each musical recording with a specific manipulation sequence of said virtual keys;
wherein said music application causes a specific musical recording to be played and highlights simultaneously the associated specific virtual keys and the corresponding real keys during the playing of the specific musical recording with the same designation;
wherein said display further displays a score board, a target bar located above said virtual musical instrument and one or more lines diverging from a common starting point and end at a point of said target bar located directly over a highlighted virtual key, thereby indicating said specific manipulation sequence of said virtual keys during the playing of the specific musical recording; and
wherein manipulation of the highlighted real keys by the player coinciding with the simultaneously displayed manipulation sequence of the highlighted virtual keys during the playing of the specific musical recording causes a positive scoring event in said score board in real-time.

2. The game system of claim 1 wherein manipulation of the highlighted real keys by the player not coinciding with the simultaneously displayed manipulation sequence of the highlighted virtual keys during the playing of the specific musical recording causes a negative scoring event in said score board.

3. The game system of claim 1 wherein no manipulation of the highlighted real keys by the player coinciding with the simultaneously displayed manipulation sequence of the highlighted virtual keys during the playing of the specific musical recording causes a negative scoring event in said score board.

4. The game system of claim 1 wherein said musical recordings comprise one of songs, song segments, musical arrangements, instrumental musical pieces or vocal musical pieces.

5. The game system of claim 1 wherein said computing unit communicates with said real musical instrument via musical instrument digital interface (MIDI) communications.

6. The game system of claim 1 further comprising a first set of speakers broadcasting sound generated from the playing of said musical recordings and/or the playing of the real musical instrument.

7. The game system of claim 6 further comprising a second set of speakers broadcasting sound generated from the playing of said real musical instrument.

8. The game system of claim 1 wherein said real musical instrument comprises one of an electronic keyboard, a synthesizer, a Keytar, a computer keyboard in which the keys are software mapped to correspond to music notes, a saxophone, a guitar, a EWI, a non-full size electronic keyboard, a touch pad or a gesture-triggered controller.

9. The game system of claim 1 wherein said display further displays one or more time prompts running along said one or more lines, respectively, and wherein said time prompts hit said target bar at said point located directly over the highlighted virtual key at the time said player needs to hit the corresponding real key.

10. The game system of claim 1 wherein said real musical instrument further comprises means for highlighting simultaneously said real keys with said virtual keys with the same designation and wherein said designation comprises one of light, colors, shapes, numbers, letters, textures, font type, font size, or key relative position.

11. The game system of claim 1 wherein said real musical instrument further comprises a lighting source for highlighting simultaneously said real keys with the same colors as the corresponding virtual keys.

12. The game system of claim 11 wherein said lighting source comprises a projector receiving an image of the lighted virtual keys of the virtual musical instrument and projecting said image onto the real keys of the real musical instrument.

13. The game system of claim 1 further comprising one or more additional real musical instruments configured to be manipulated by said player or by one or more additional players and wherein said display is further configured to display one or more additional virtual music instruments corresponding to said one or more additional real musical instruments.

14. The game system of claim 1 wherein said computing unit comprises one of a computer, a Playstation, an Xbox, a Wii, a PlayStation, a Nintendo DS, a game controlling device or a handheld game controlling device.

15. The game system of claim 1 wherein said display comprises one of a computer display, a television display, a projected display, a video game console, or an arcade machine display.

16. A method for an interactive musical game comprising
providing a real musical instrument comprising real keys configured to be manipulated by a player for playing music and thereby providing game input;
providing a computing unit communicating with said real musical instrument and comprising a database and a music application, wherein said database comprises musical recordings and data specific to each musical recording that associate pitches of each musical recording with a specific manipulation sequence of said virtual keys;
providing a display connected to said computing unit and configured to display a virtual musical instrument corresponding to said real musical instrument, wherein said virtual musical instrument comprises virtual keys corresponding to said real keys of said real musical instrument;
wherein said music application causes a specific musical recording to be played and highlights simultaneously the associated specific virtual keys and the corresponding real keys during the playing of the specific musical recording;
wherein said display further displays a score board, a target bar located above said virtual musical instrument and one or more lines diverging from a common starting point and end at a point of said target bar located directly over a highlighted virtual key, thereby indicating said specific manipulation sequence of said virtual keys during the playing of the specific musical recording; and
wherein manipulation of the highlighted real keys by the player coinciding with the simultaneously displayed manipulation sequence of the highlighted virtual keys during the playing of the specific musical recording causes a positive scoring event in said score board.

17. The method of claim 16 wherein manipulation of the highlighted real keys by the player not coinciding with the simultaneously displayed manipulation sequence of the highlighted virtual keys during the playing of the specific musical recording causes a negative scoring event in said score board.

18. The method of claim 16 wherein no manipulation of the highlighted real keys by the player coinciding with the simultaneously displayed manipulation sequence of the highlighted virtual keys during the playing of the specific musical recording causes a negative scoring event in said score board.

19. The method of claim 16 further comprising providing one or more additional real musical instruments configured to be manipulated by said player or by one or more additional players and wherein said display is further configured to display one or more additional virtual music instruments corresponding to said one or more additional real musical instruments.

20. The method of claim 16 wherein said real musical instrument further comprises means for highlighting simultaneously said real keys with said virtual keys with the same designation and wherein said designation comprises one of light, colors, shapes, numbers, letters, textures, font type, font size, or key relative position.
